(19) United States
(12) Patent Application Publication
(10) Pub. No.: US 2014/0325134 A1
(43) Pub. Date: Oct. 30, 2014

(54) PREARRANGING DATA TO COMMIT TO NON-VOLATILE MEMORY

(71) Applicants: David G. Carpenter, Cypress, TX (US); Philip K. Wong, Austin, TX (US); William C. Hallowell, Spring, TX (US); Craig M. Belusar, Tomball, TX (US)

(72) Inventors: David G. Carpenter, Cypress, TX (US); Philip K. Wong, Austin, TX (US); William C. Hallowell, Spring, TX (US); Craig M. Belusar, Tomball, TX (US)

(21) Appl. No.: 14/368,761

(22) PCT Filed: May 1, 2012
(86) PCT No.: PCT/US2012/035913

§ 371 Date: Jun. 25, 2014

(51) Int. Cl. G06F 12/02; G06F 12/10

(52) U.S. Cl. CPC G06F 12/0246; G06F 12/1009
USPC 711/103

(57) ABSTRACT

An apparatus includes a hybrid memory module, and the hybrid memory module includes volatile memory and non-volatile memory. Data is prearranged in the volatile memory. The data is committed to the non-volatile memory, as prearranged, in a single write operation when a size of the prearranged data reaches a threshold.

### BACKGROUND

Any device that stores data or instructions needs memory, and there are two broad types of memory: volatile memory and nonvolatile memory. Volatile memory loses its stored data when it loses power or power is not refreshed periodically. Non-volatile memory, however, retains information without a continuous or periodic power supply.

Random access memory (“RAM”) is one type of volatile memory. As long as the addresses of the desired cells of RAM are known, RAM may be accessed in any order. Dynamic random access memory (“DRAM”) is one type of RAM. A capacitor is used to store a memory bit in DRAM, and the capacitor may be periodically refreshed to maintain a high electron state. Because the DRAM circuit is small and inexpensive, it may be used as memory for computer systems.

Flash memory is one type of non-volatile memory, and flash memory may be accessed in pages. For example, a page of flash memory may be erased in one operation or one “flash.” Accesses to flash memory are relatively slow compared with accesses to DRAM. As such, flash memory may be used as long term or persistent storage for computer systems.

### BRIEF DESCRIPTION OF THE DRAWINGS

For a detailed description of various examples, reference will now be made to the accompanying drawings in which:

FIG. 1 illustrates a system for prearranging data to commit to non-volatile memory in accordance with at least one illustrated example;

FIG. 2 illustrates a method of prearranging data to commit to non-volatile memory in accordance with at least one illustrated example;

FIG. 3 illustrates an apparatus for prearranging data to commit to non-volatile memory in accordance with at least one illustrated example; and

FIG. 4 illustrates a non-transitory computer readable medium for prearranging data to commit to non-volatile memory in accordance with at least one illustrated example.

### DETAILED DESCRIPTION

By prearranging, in volatile memory, data to be committed to non-volatile memory such as flash memory, time and space can be used efficiently. Specifically, by combining many small write requests into a relatively few large write operations, the speed, performance, and throughput of non-volatile memory may be improved. Placing metadata in a predictable location on each page of flash memory also improves speed, performance, and throughput of non-volatile memory. The gains in efficiency greatly outweigh any time and space used to prearrange the data.

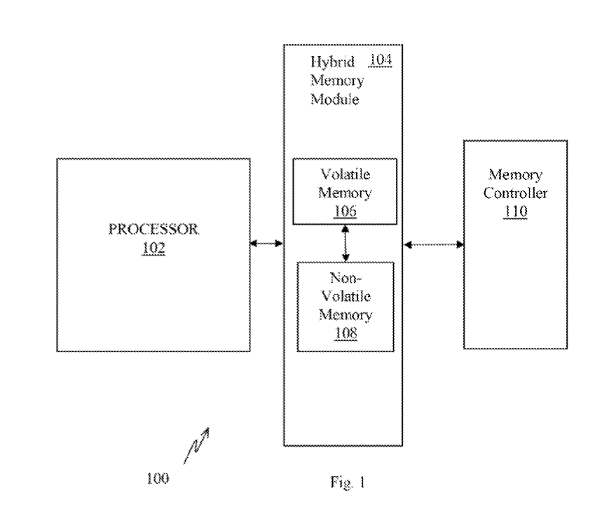

FIG. 1 illustrates a system 100 comprising a hybrid memory module 104 that may comprise volatile memory 106 and non-volatile memory 108. The system 100 of FIG. 1 prearranges data in the volatile memory 106 for storage in the non-volatile memory 108 in accordance with at least some examples. The system 100 also may comprise a processor 102, which may be referred to as a central processing unit (“CPU”). The processor 102 may be implemented as one or more CPU chips, and may execute instructions, code, and computer programs. The processor 102 may be coupled to the hybrid memory module 104 in at least one example.

The hybrid memo module 104 may be coupled to a memory controller 110, which may comprise circuit logic to manage data flow by scheduling reading and writing to memory. In at least one example, the memory controller 110 may be integrated with the processor 102 or the hybrid memory module 104. As such, the memory controller 110 or processor 102 may prearrange data in volatile memory 106, and commit the prearranged data to non-volatile memory 108.

In at least one example, half of the total memory in the hybrid memory module 104 may be implemented as volatile memory 106 and half may be implemented as non-volatile memory 108. In various other examples, the ratio of volatile memory 106 to non-volatile memory 108 may be other than equal amounts.

In volatile memory 106 such as DRAM, each byte may be individually addressed, and data may be accessed in any order. However, in non-volatile memory 108, data is accessed in pages. That is, in order to read a byte of data, the page of data in which the byte is located should be loaded. Similarly, in order to write a byte of data, the page of data in which the byte should be written should be loaded. As such, it is economical to write a page of non-volatile memory 108 together in one write operation. Specifically, the number of accesses to the page may be reduced resulting in time saved and reduced input/output wear of the non-volatile memory 108. Furthermore, in at least one example, a program or operating system may only be compatible with volatile memory and may therefore attempt to address individual bytes in the non-volatile memory. In such a scenario, the prearranging of data may help the non-volatile memory 108 be compatible with such programs or operating systems by allowing for the illusion of byte-addressability of non-volatile memory 108.

The volatile memory 106 may act as a staging area for the non-volatile memory 108. That is, data may be prearranged, or ordered, in the volatile memory 106 before being stored in the non-volatile memory 108 in the same arrangement or order. In at least one example, the data prearranged in the volatile memory 106 comprises write data and metadata. The write data may comprise data associated with write requests. The metadata may comprise an address mapping of the write data. For example, the address mapping may comprise a logical address to physical address mapping. When the data is requested, it may be requested by logical address. The metadata may be consulted to determine the physical address associated with the logical address in the request, and the requested data may be retrieved from the physical address. The metadata may be stored contiguously, i.e. in a sequential set of addresses, and the write data may be stored contiguously as well (in a separate set of sequential addresses). In at least one example, the size of these contiguous blocks of data may be based on a page size of the non-volatile memory 108, For example, a page size of non-volatile memory 108 may be 64 kilobytes. As such, metadata and write data may be accumulated in volatile memory 106 in their respective contiguous blocks until the threshold of 64 kilobytes of combined data is reached. Because metadata may be smaller than write data, 4 kilobytes of the 64 kilobytes may comprise metadata while 60 kilobytes of the 64 kilobytes may comprise write data. In various examples, other ratios may occur.

In another example, the page size of the non-volatile memory 108 may be 128 kilobytes. As such, metadata and write data may be accumulated in volatile memory 106 until the threshold of 128 kilobytes of combined data is reached. Because metadata may be smaller than write data, 8 kilobytes of the 128 kilobytes may comprise metadata while 120 kilobytes of the 128 kilobytes may comprise write data. In various examples, other ratios may occur.

In at least one example, the metadata block is stored before (at lower numbered addresses) the write data block in volatile memory 106. As such, when the combined data is committed to non-volatile memory 108, metadata will appear at the beginning (at lower numbered addresses) of each page of the non-volatile memory 108. In another example, the metadata is placed after the write data. As such, the metadata will appear at the end of each page of non-volatile memory 108.

Once the threshold amount of data has been accumulated and prearranged in volatile memory 106, the data may be committed to non-volatile memory 108 as prearranged. The data may be committed in a single write operation, In at least one example, the threshold is a variable. That is, the amount of data accumulated that triggers storage to non-volatile memory is not constant. Rather, it changes based on whether further data would cause the size of the prearranged data to exceed a page size of the non-volatile memory. For example, the write requests may be prearranged in the order they were received; as such, the oldest write request associated with data that has not already been prearranged is next for prearrangement. If the next write request is associated with data that would cause the prearranged data to exceed a, e.g., 64 kilobyte page size of non-volatile memory 108, then the already prearranged data is committed to non-volatile memory 108, and the data associated with the next write request is used as the first accumulation to be committed to the next page of non-volatile memory 108. In this way, the page size of the non-volatile memory 108 may be approached or equaled by the size of the prearranged data, but not exceeded in at least some examples.

In at least one example, an amount of volatile memory needed for prearranging the data is calculated based on a rate at which write requests are received and a speed at which data can be committed to the non-volatile memory. For example, if an average of 4 kilobytes of data are stored in volatile memory 106 for each write request, the total amount of memory that should be stored over a period of time can be calculated if the frequency of the write requests are known. Also, if data is committed slower than that frequency, the amount of buffer space needed may be calculated. This amount of buffer space can be divided into regions equal to the page size of non-volatile memory, and these regions may be used as a circular queue. That is, once a region has been committed to non-volatile memory, that region may be placed at the end of a queue and may be overwritten when the region reaches the front of the queue. In at least one example, committing a region of data to non-volatile memory 108 may be performed simultaneously with prearranging the next regions in the queue.

The hybrid memory module 104 may also comprise a power sensor in at least one example. The power sensor may comprise logic that detects an imminent or occurring power failure and consequently triggers a backup of volatile memory 106 to non-volatile memory 108 or a check to ensure that non-volatile memory 108 is already backing up or has already backed up volatile memory 106. For example, the power sensor may be coupled to a power supply or charging capacitor coupled to the hybrid memory module 104. If the supplied power falls below a threshold, the backup may be triggered. In this way, the data in volatile memory 106 may be protected during a power failure.

The hybrid memory module 104 and volatile memory 106 may act as a cache in at least one example. For example, should data be requested that has not yet been committed to non-volatile memory 108, the volatile memory 106 may be accessed to retrieve the requested data. In this way, an inventory of data may be maintained with data being marked stale or not stale, much like a cache.

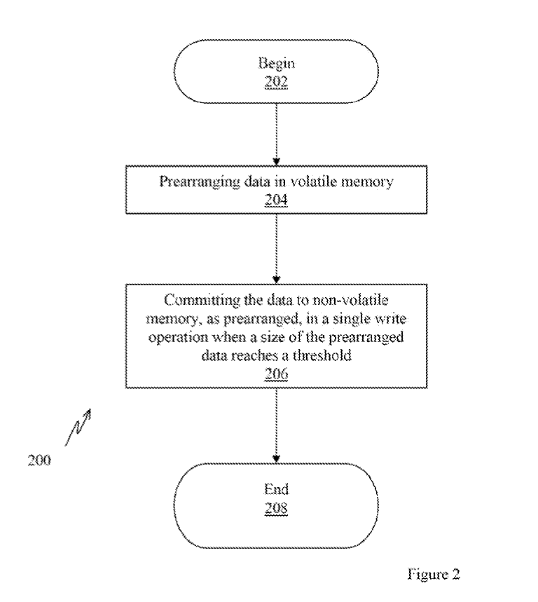

FIG. 2 illustrates a method 200 of prearranging data to commit to non-volatile memory beginning at 202 and ending at 208. At 204, data may be prearranged, or ordered, in the volatile memory 106 before being stored in the non-volatile memory 108 in the same arrangement or order. In at least one example, the data prearranged in the volatile memory 106 comprises write data and metadata. The write data may comprise data associated with write requests. The metadata may comprise an address mapping of the write data. For example, the address mapping may comprise a logical address to physical address mapping. When the data is requested, it may be requested by logical address. The metadata may be consulted to determine the physical address associated with the logical address in the request, and the requested data may be retrieved from the physical address. The metadata may be stored contiguously, i.e. in a sequential set of addresses, and the write data may be stored contiguously as well (in a separate set of sequential addresses). In at least one example, the size of these contiguous blocks of data may be based on a page size of the non-volatile memory 108. For example, a page size of non-volatile memory 108 may be 64 kilobytes. As such, metadata and write data may be accumulated in volatile memory 106 in their respective contiguous blocks until the threshold of 64 kilobytes of combined data is reached. Because metadata may be smaller than write data, 4 kilobytes of the 64 kilobytes may comprise metadata while 60 kilobytes of the 64 kilobytes may comprise write data. In various examples, other ratios may occur.

In another example, the page size of the non-volatile memory 108 may be 128 kilobytes. As such, metadata and write data may be accumulated in volatile memory 106 until the threshold of 128 kilobytes of combined data is reached. Because metadata may be smaller than write data, 8 kilobytes of the 128 kilobytes may comprise metadata while 120 kilobytes of the 128 kilobytes may comprise write data. In various examples, other ratios may occur.

In at least one example, the metadata block is stored before (at lower numbered addresses) the write data block in volatile memory 106. As such, when the combined data is committed to non-volatile memory 108, metadata will appear at the beginning (at lower numbered addresses) of each page of the non-volatile memory 108. In another example, the metadata is placed after the write data. As such, the metadata will appear at the end of each page of non-volatile memory 108.

At 206, the data may be committed to non-volatile memory 108 as prearranged. The data may be committed in a single write operation. In at least one example, the threshold is a variable. That is, the amount of data accumulated that triggers storage to non-volatile memory is not constant. Rather, it changes based on whether further data would cause the size of the prearranged data to exceed a page size of the non-volatile memory. For example, the write requests may be prearranged in the order they were received; as such, the oldest write request associated with data that has not already been prearranged is next for prearrangement. If the next write request is associated with data that would cause the prearranged data to exceed a, e.g., 64 kilobyte page size of non-volatile memory 108, then the already prearranged data is committed to non-volatile memory 108, and the data associated with the next write request is used as the first accumulation to be committed to the next page of non-volatile memory 108. In this way, the page size of the non-volatile memory 108 may be approached or equaled by the size of the prearranged data, but not exceeded in at least some examples.

In at least one example, an amount of volatile memory needed for prearranging the data is calculated based on a rate at which write requests are received and a speed at which data can be committed to the non-volatile memory. For example, if an average of 4 kilobytes of data are stored in volatile memory 106 for each write request, the total amount of memory that should be stored over a period of time can be calculated if the frequency of the write requests are known. Also, if data is committed slower than that frequency, the amount of buffer space needed may be calculated. This amount of buffer space can be divided into regions equal to the page size of non-volatile memory, and these regions may be used as a circular queue. That is, once a region has been committed to non-volatile memory, that region may be placed at the end of a queue and may be overwritten when the region reaches the front of the queue. In at least one example, committing a region of data to non-volatile memory 108 may be performed simultaneously with prearranging the next regions in the queue.

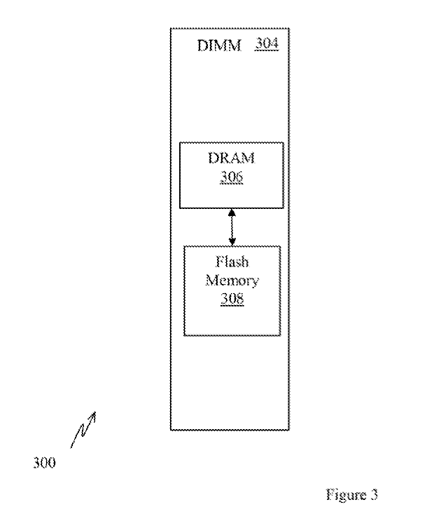

FIG. 3 illustrates an apparatus 300 for prearranging data to commit to flash memory 108 in accordance with at least one illustrated example. The apparatus 300 may comprise a hybrid dual inline memory module (“DIMM”) 304 in at least one example. The hybrid DIMM 304 may comprise DRAM 306 and flash memory 308. As such, both DRAM 306 and flash memory 308 may be provided on the same DIMM 304 and be controlled by the same memory controller. DRAM 306 may be volatile memory because each bit of data may be stored within a capacitor that is powered periodically to retain the bits. Flash memory 308, which stores bits using one or more transistors, may be non-volatile memory. In various examples, other types of volatile memory and non-volatile memory are used. In at least one example, half of the total DIMM memory may be implemented as DRAM 306 and half may be implemented as flash memory 308. In various other examples, the ratio of DRAM 306 to flash memory 308 may be other than equal amounts. The hybrid DIMM 304 may fit in the DIMM slot of electronic devices without assistance from adaptive hardware.

In DRAM 306, each byte may be individually addressed. However, in flash memory 308, data is accessed in pages. That is, in order to read a byte of data, the page of data in which the byte is located should be loaded. Similarly, in order to write a byte of data, the page of data in which the byte should be written should be loaded. As such, it is economical to write entire pages of flash memory 308 together in one write operation. Specifically, the number of accesses to the page may be reduced resulting in reduced input/output wear of the flash memory 308. Furthermore, in at least one example, a program or operating system may only be compatible with DRAM 306 and therefore attempt to address individual bytes in the flash memory 308. In such a scenario, the prearranging of data may help the flash memory 308 be compatible with such programs or operating systems by allowing for the illusion of byte-addressability of flash memory 308.

The DRAM 306 may act as a staging area for the flash memory 308. That is, data may be prearranged, or ordered, in the DRAM 306 before being stored in the flash memory 308 in the same arrangement or order In at least one example, the data prearranged in the DRAM 306 comprises write data and metadata. The write data may comprise data associated with write requests. The metadata may comprise an address mapping of the write data. For example, the address mapping may comprise a logical address to physical address mapping. When the data is requested, it may be requested by logical address. The metadata may be consulted to determine the physical address associated with the logical address in the request, and the requested data may be retrieved from the physical address. The metadata may be stored contiguously, i.e. in a sequential set of addresses, and the write data may be stored contiguously as well (in a separate set of sequential addresses). In at least one example, the size of these contiguous blocks of data may be based on a page size of the flash memory 308. For example, a page size of flash memory 308 may be 64 kilobytes. As such, metadata and write data may be accumulated in DRAM 306 in their respective contiguous blocks until the threshold of 64 kilobytes of combined data is reached. Because metadata may be smaller than write data, 4 kilobytes of the 64 kilobytes may comprise metadata while 60 kilobytes of the 64 kilobytes may comprise write data. In various examples, other ratios may occur.

In another example, the page size of the flash memory 308 may be 128 kilobytes. As such, metadata and write data may be accumulated in DRAM 306 until the threshold of 128 kilobytes of combined data is reached. Because metadata may be smaller than write data, 8 kilobytes of the 128 kilobytes may comprise metadata while 120 kilobytes of the 128 kilobytes may comprise write data. In various examples, other ratios may occur.

In at least one example, the metadata block is stored before (at lower numbered addresses) the write data block in DRAM 306. As such, when the combined data is committed to flash memory 308, metadata will appear at the beginning (at lower numbered addresses) of each page of the flash memory 308. In another example, the metadata is placed after the write data. As such, the metadata will appear at the end of each page of flash memory 308.

Once the threshold amount of data has been accumulated and prearranged in DRAM 306, the data may be committed to flash memory 308 as prearranged. The data may be committed in a single write operation, In at least one example, the threshold is a variable. That is, the amount of data accumulated that triggers storage to flash memory 308 is not constant. Rather, it changes based on whether further data would cause the size of the prearranged data to exceed a page size of the flash memory 308. For example, the write requests may be prearranged in the order they were received; as such, the oldest write request associated with data that has not already been prearranged is next for prearrangement. If the next write request is associated with data that would cause the prearranged data to exceed a, e.g., 64 kilobyte page size of flash memory 308, then the already prearranged data is committed to flash memory 308, and the data associated with the next write request is used as the first accumulation to be committed to the next page of flash memory 308. In this way, the page size of the flash memory 308 may be approached or equaled by the size of the prearranged data, but not exceeded in at least some examples.

In at least one example, an amount of DRAM 306 needed for prearranging the data is calculated based on a rate at which write requests are received and a speed at which data can be committed to the flash memory 308. For example, if an average of 4 kilobytes of data are stored in DRAM 306 for each write request, the total amount of memory that should be stored over a period of time can be calculated if the frequency of the write requests are known. Also, if data is committed slower than that frequency, the amount of buffer space needed may be calculated. This amount of buffer space can be divided into regions equal to the page size of flash memory 308, and these regions may be used as a circular queue. That is, once a region has been committed to flash memory 308, that region may be placed at the end of a queue and may be overwritten when the region reaches the front of the queue. In at least one example, committing a region of data to flash memory 308 may be performed simultaneously with prearranging the next regions in the queue.

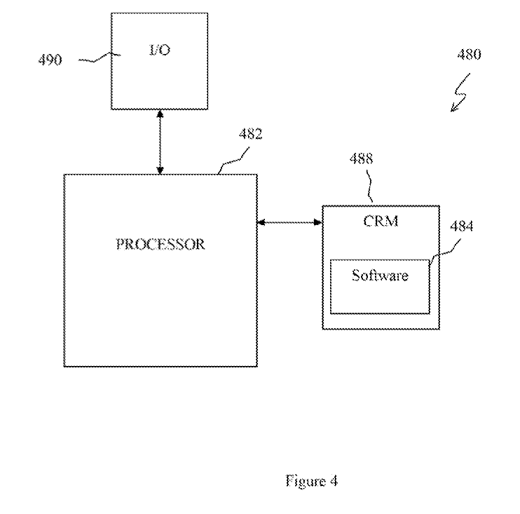

The system described above may be implemented on any particular machine or computer with sufficient processing power, memory resources, and throughput capability to handle the necessary workload placed upon the computer. FIG. 4 illustrates a particular computer system 480 suitable for implementing one or more examples disclosed herein. The computer system 480 includes a hardware processor 482 (which may be referred to as a central processor unit or CPU) that is in communication with memory devices including storage 488, and input/output (10) 490 devices. The processor may be implemented as one or more CPU chips.

In various embodiments, the storage 488 comprises a non-transitory storage device such as volatile memory (e.g., RAM), nonvolatile storage (e.g., Flash memory, hard disk drive, CD ROM, etc.), or combinations thereof. The storage 488 comprises computer-readable software 484 that is executed by the processor 482. One or more of the actions described herein are performed by the processor 482 during execution of the software 484.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An apparatus, comprising;
a hybrid memory module comprising:
volatile memory; and
non-volatile memory;
wherein data is prearranged in the volatile memory and the data is committed to the non-volatile memory, as prearranged, in a single write operation when a size of the prearranged data reaches a threshold.

2. The apparatus of claim 1, wherein the threshold is a variable threshold comprising an amount such that further data would cause the size of the prearranged data to exceed a page size of the non-volatile memory.

3. The apparatus of claim 2, wherein the further data comprises write data received as part of the oldest write request that is not already prearranged.

4. The apparatus of claim 1, wherein the data prearranged in the volatile memory comprises write data and metadata; and the metadata comprises an address mapping of the write data.

5. The apparatus of claim 4, wherein the write data is stored into a page of the non-volatile memory; the metadata is stored into the page; and the metadata is stored contiguously in the non-volatile memory.

6. The apparatus of claim 1, wherein an amount of volatile memory needed for prearranging the data is calculated based on a rate at which write requests are received and a speed at which data can be committed to the non-volatile memory.

7. The apparatus of claim 6, wherein the amount of volatile memory needed is divided into regions, each region is the size of a page size of the non-volatile memory; and the regions are used as a circular queue.

8. A method, comprising:
prearranging data in volatile memory;
committing the data to non-volatile memory, as prearranged, in a single write operation when a size of the prearranged data reaches a threshold.

9. The method of claim 8, wherein the threshold is a variable threshold comprising an amount such that further data would cause the size of the prearranged data to exceed a page size of the non-volatile memory.

10. The method of claim 9, wherein the further data comprises write data received as part of the oldest write request that is not already prearranged.

11. The method of claim 8, wherein the data prearranged in the volatile memory comprises write data and metadata; and the metadata comprises an address mapping of the write data.

12. The method of claim 11, further comprising storing the write data into a page of the non-volatile data, storing the metadata into the page, and storing the metadata contiguously in the non-volatile memory.

13. The method of claim 8, further comprising calculating an amount of volatile memory needed for prearranging the data based on a rate at which write requests are received and a speed at which data can be committed to the non-volatile memory.

14. The method of claim 13, further comprising dividing the amount of volatile memory needed into regions, each region the size of a page size of the non-volatile memory; and using the regions as a circular queue.

15. A system, comprising:
a hybrid dual in-line memory module (“DIMM”) comprising dynamic random access memory (“DRAM”); and
flash memory;
wherein data is prearranged in the DRAM and the data is committed to the flash memory, as prearranged, in a single write operation when a size of the prearranged data reaches a threshold.
